(19) United States
(12) Patent Application Publication
(10) Pub. No.: US 2019/0206241 A1
(43) Pub. Date: Jul. 4, 2019

(54) CONCEPT FOR DETECTING THE SURROUNDINGS OF A MOTOR VEHICLE

(71) Applicant: Robert Bosch GmbH, Stuttgart (DE)

(72) Inventors: Albrecht Irion, Stuttgart (DE); Philipp Mayer, Ho Chi Minh City (VN); Rolf Nicodemus, Bietigheim-Bissingen (DE); Stefan Nordbruch, Kornwestheim (DE)

(21) Appl. No.: 16/331,393

(22) PCT Filed: Jul. 31, 2017
(86) PCT No.: PCT/EP2017/069351

§ 371 Date: Mar. 7, 2019

(30) Foreign Application Priority Data
Sep. 9, 2016 (DE) 10 2016 217 237.9

(51) Int. Cl. G08G 1/04; G08G 1/042

(52) U.S. Cl. CPC G08G 1/04; G08G 1/144; G08G 1/042

(57) ABSTRACT

A device for detecting the surroundings of a motor vehicle includes a parking control unit, a first data processing device, and one or more sensor units that each includes one or more surroundings sensors for detecting the surroundings of a motor vehicle. The parking control unit is connected between the sensor units and the first data processing device.

### CROSS-REFERENCE TO RELATED APPLICATIONS

The present application is the national stage of International Pat. App. No. PCT/EP2017/069351 filed Jul. 31, 2017, and claims priority under 35 U.S.C. § 119 to DE 10 2016 217 237.9, filed in the Federal Republic of Germany on Sep. 9, 2016, the content of each of which are incorporated herein by reference in their entireties.

### FIELD OF THE INVENTION

The present invention relates to a motor vehicle, a device and a method for detecting the surroundings of the motor vehicle, a method for processing the motor vehicle, a system for detecting the surroundings of the motor vehicle, and a computer program.

### BACKGROUND

Systems for ascertaining parking spaces on a roadside are known per se. They generally include two subsystems: a first subsystem is situated in the motor vehicle and a second subsystem is situated in a cloud infrastructure.

The subsystem that is situated in the motor vehicle includes surroundings sensors that scan a roadside when the motor vehicle is traveling along the roadside. The raw sensor data are subsequently further processed in a parking control unit of the motor vehicle. This means, for example, that occupied or vacant spaces as well as their dimensions or distances from one another are ascertained in the parking control unit.

In a so-called “head unit,” the main control unit of the motor vehicle, or optionally in another computer, a position of the occupied or vacant spaces is additionally ascertained using a GPS sensor, for example.

These data (position of the ascertained space and its occupancy state, i.e., vacant or occupied) are sent via a communication unit of the motor vehicle to the subsystem situated in the cloud infrastructure.

The subsystem situated in the cloud infrastructure processes these data and determines, for example, whether or not a vacant space is an entry point. These further processed data are then, for example, transmitted back to the motor vehicle or to other motor vehicles, so that the information contained in these further processed data can be displayed in the particular motor vehicle and/or provided via the Internet.

Thus, an appropriately designed parking control unit should be situated in the motor vehicle. In particular, a position ascertainment component such as a GPS sensor should be situated within the motor vehicle. In particular, a communication component for communicating with the subsystem that is situated within the cloud infrastructure should be situated within the motor vehicle.

In addition, modifications to a vehicle-internal communication, for example to a bus system of the motor vehicle, are generally necessary.

For these reasons, subsequently installing the first subsystem in a completed motor vehicle, i.e., after its manufacture, is possible, if at all, only with significant modifications.

### SUMMARY

An object underlying the present invention is to provide for efficiently detecting the surroundings of a motor vehicle, which overcomes the above-described disadvantages and efficiently allows a motor vehicle to become part of a system for ascertaining parking spaces also subsequently, i.e., after its manufacture.

According to one aspect, a device for detecting the surroundings of a motor vehicle includes: one or more sensor units, each including one or more surroundings sensors for detecting the surroundings of a motor vehicle and a communication interface for the wired transmission of surroundings sensor data corresponding to the particular detection; a parking control unit connected between the particular communication interface of the one or more sensor units and the first data processing device and including a communication interface that is designed for receiving by wire the surroundings sensor data; and a first data processing device that includes a communication module designed for receiving by wire, using the communication interface of the parking control unit, output data based on the surroundings sensor data, and designed for transmitting the data and/or surroundings data based on the data to a second data processing device via a wireless communications network, so that the second data processing device can transmit the data and/or the surroundings data to a cloud server via a further wireless communications network.

According to another aspect, a motor vehicle is provided that includes the device for detecting the surroundings of a motor vehicle.

According to another aspect, a method for detecting the surroundings of a motor vehicle, using the device for detecting the surroundings of a motor vehicle, is provided, including the following steps: detecting the surroundings of a motor vehicle using the surroundings sensor(s), transmitting by wire surroundings sensor data, corresponding to the detection, using the particular communication interface of the sensor unit(s), receiving by wire the surroundings sensor data using the parking control unit, wired outputting of data based on the surroundings sensor data using the communication interface of the parking control unit, wired reception of the output data using the communication module of the first data processing device, and transmitting the data and/or surroundings data based on the data to a second data processing device via a wireless communications network, using the first data processing device, so that the second data processing device can transmit the data and/or the surroundings data to a cloud server via a further wireless communications network.

According to another aspect, a method for perfecting a motor vehicle is provided, the motor vehicle including one or more sensor units, each including a parking control unit and one or more surroundings sensors for detecting the surroundings of the motor vehicle, and a communication interface for the wired transmission of surroundings sensor data corresponding to the particular detection via a bus, in particular a CAN bus, of the motor vehicle, the parking control unit including a bus communication interface that is designed for wired reception of the surroundings sensor data via the bus, a first data processing device being installed in the motor vehicle in such a way that the parking control unit is connected between the particular communication interface of the one or more sensor units and the first data processing device, the first data processing device including a communication module that is designed for receiving, by wire, output data based on the surroundings sensor data using the communication interface of the parking control unit, the communication module being designed for transmitting the data and/or surroundings data based on the data to a second data processing device via a wireless communications network, so that the second data processing device can transmit the data and/or the surroundings data to a cloud server via a further wireless communications network.

According to another aspect of the present invention, a system for detecting the surroundings of a motor vehicle includes: the device for detecting the surroundings of a motor vehicle and a cloud server that includes a communication interface that is designed for receiving the data and/or the surroundings data via the further wireless communications network.

According to another aspect, a computer program includes program code for carrying out the method for detecting the surroundings of a motor vehicle when the computer program is executed on a computer.

The present invention is based on the finding that the above-mentioned object can be achieved by providing a first data processing device that receives output data by wire from the parking control unit. These data are based on the surroundings sensor data. For example, the data correspond to the surroundings sensor data. For example, the data include the surroundings sensor data. Surroundings sensor data include raw surroundings sensor data, for example, and/or are raw surroundings sensor data, for example.

The first data processing device wirelessly transmits the received data and/or surroundings data based on the received data to a second data processing device via a wireless communications network. These surroundings data are thus ascertained, for example, based on the data that have been output by the parking control unit, using the first data processing device.

The second data processing device can thus advantageously transmit these data and/or surroundings data to a cloud server via a further wireless communications network. This means that the surroundings sensor data and/or the surroundings data are transmitted from the first data processing device to the second data processing device not by wire via a bus, but instead are transmitted wirelessly. As a result, it is thus advantageously not necessary to make modifications to a motor vehicle bus for a communication link between the first data processing device and the second data processing device.

Thus, the first data processing device is not directly connected to the sensor units or to the sensor unit, but, rather, is connected indirectly via the parking control unit.

As a result, a motor vehicle after manufacture can participate as a part of a system for ascertaining parking spaces, simply by installing a first data processing device. Thus, after producing the motor vehicle, in addition to the parking control unit, the motor vehicle also includes the first data processing device, which communicates with the second data processing device, which in turn communicates with the cloud server. Thus, a motor vehicle that is produced in this way can efficiently take part in a system for ascertaining parking spaces, although it was not able to do so previously. This is due to the fact that prior to the perfection of the motor vehicle, the motor vehicle lacked, for example, suitable options for communicating with the cloud server. The parking control unit itself is generally not capable of or designed for communicating with the cloud server on its own. Thus, by providing the first data processing device, a first step is taken in establishing a communication link with the cloud server.

The second data processing device then takes over the communication between the first data processing device and the cloud server. Such a second data processing device can be efficiently provided. For example, it is sufficient here, as described below, to provide a mobile terminal or a main control unit.

The second data processing device can, for example, transmit the data, which it has obtained from the first data processing device, directly to the cloud server. In addition or instead, the second data processing device can further process the data it has obtained from the first data processing device, and transmit the further processed data to the cloud server. These further processed data can also be referred to below as surroundings data.

Surroundings data thus generally refer to data based on the data that have been output using the parking control unit, regardless of whether they are output or relayed using the first or the second data processing device or the cloud server. Surroundings data correspond, for example, precisely to the data that have been output by the parking control unit. Drivers of motor vehicles generally already carry a mobile terminal, such as a mobile telephone, with them. The mobile terminal then takes over the communication between the first data processing device and the cloud server.

Motor vehicles generally already include a main control unit, so that a suitable device is already provided here for communicating with the cloud server.

In particular, according to the present invention, it is not necessary to make changes in or on the sensor units. Thus, the sensor units that are already installed in the motor vehicle within the scope of its manufacture can continue to be used.

Likewise, it is generally no longer necessary to modify a parking control unit that is already present.

In addition, according to the present invention it is not necessary to make changes, at least significant changes, on and/or in a bus of the motor vehicle, provided that the data, for example the surroundings sensor data, are indirectly transmitted or sent or output to the first data processing device via the parking control unit.

According to an example embodiment, the device includes the second data processing device, the second data processing device being designed for transmitting the data and/or the surroundings data to the cloud server via the further wireless communications network.

According to an example embodiment, the second data processing device is a mobile terminal, in particular a mobile telephone. This yields, for example, a technical advantage that, for example, a mobile terminal, in particular a mobile telephone, of a driver of the motor vehicle can be efficiently utilized.

According to an example embodiment, the second data processing device is a main control unit for a motor vehicle. This yields, for example, a technical advantage that the main control unit can be efficiently utilized.

Within the meaning of the description, a main control unit can be referred to as a head unit, for example.

According to an example embodiment, the communication module of the first data processing device is directly connected on the output side to the communication interface of the parking control unit. This yields, for example, a technical advantage that the data can be tapped directly at the parking control unit.

For example, the parking control unit is and/or can be connected to the first data processing device via a dedicated communication line, for example via a dedicated communication cable, the communication line being different from a bus line, for example different from a bus cable, of the motor vehicle. Thus, the communication link between the parking control unit and the first data processing device is designed or formed, for example, so that it is separate from a bus of the motor vehicle.

In an example embodiment, the communication module of the first data processing device is connected to the communication interface of the parking control unit via a bus line, in particular a CAN bus line. This yields, for example, a technical advantage that no changes have to be made to the parking control unit, in particular to the communication interface of the parking control on the output side.

This means in particular that the first data processing device is connected to the parking control unit via a bus. The first data processing device is thus connected in particular to a bus system of the motor vehicle.

The communication interface of the parking control unit is designed in particular for outputting the data to the bus.

According to an example embodiment, the communication module includes a first communication interface, in particular a bus communication interface, for wired reception of the data, and a second communication interface, in particular a WLAN or a Bluetooth communication interface, for transmitting the data and/or the surroundings data to the second data processing device. This yields, for example, a technical advantage that the data can be efficiently transmitted, i.e., in particular transmitted and/or received.

This means, for example, that the wireless communications network is a WLAN communications network or a Bluetooth communications network, for example.

This means, for example, that the surroundings sensor data are indirectly transmitted via the parking control unit from the sensor unit(s) to the communication module of the first data processing device via a bus communication system.

A bus communication system can also be referred to as a bus system. Within the meaning of this description, a bus includes a CAN bus and/or a FlexRay bus, for example. This means in particular that the bus system includes a CAN bus and/or a FlexRay bus, for example. Within the meaning of the description, a bus can be referred to in particular as a motor vehicle bus and/or as a communication bus.

According to an example embodiment, the further wireless communications network includes a mobile radio communications network and/or a WLAN communications network.

In an example embodiment, the second data processing device includes a first communication interface, in particular a WLAN or a Bluetooth communication interface, for wirelessly receiving the surroundings sensor data and/or the surroundings data via the wireless communications network, and a second communication interface, in particular a mobile radio communication interface or WLAN communication interface, for transmitting the surroundings sensor data and/or the surroundings data to the cloud server via the further communications network.

If the further communications network is a WLAN communications network, the communication interface, for example, can be used for transmitting the surroundings data and/or the surroundings sensor data, provided that it is designed as a WLAN communication interface.

According to an example embodiment, the parking control unit and/or the first data processing device and/or the second data processing device are/is designed to ascertain, based on the data, dimensions of a vacant space in the surroundings and/or dimensions of a space in the surroundings that is occupied by a motor vehicle, and to ascertain surroundings data corresponding to the ascertainment of the particular dimensions. This yields in particular a technical advantage that the parking control unit and/or the first data processing device and/or the second data processing device can be efficiently utilized. This yields in particular the technical advantage that the cloud server can be relieved of this task.

In an example embodiment, a position sensor for detecting a position of the motor vehicle is provided, the first data processing device being designed for transmitting position data corresponding to the detection of the position to the second data processing device, so that the second data processing device can transmit the position data to the cloud server via the further wireless communications network. This yields in particular a technical advantage that the position of the detected surroundings can be efficiently ascertained, and can be efficiently provided to the cloud server remote from the motor vehicle.

According to an example embodiment, a position sensor for detecting a position of the motor vehicle is provided, the second data processing device being designed for transmitting position data corresponding to the detection of the position to the cloud server via the further wireless communications network. This yields in particular a technical advantage that the position of the detected surroundings can be efficiently ascertained, and can be efficiently provided to the cloud server remote from the motor vehicle.

According to an example embodiment, the position sensor is integrated into the first data processing device or into the second data processing device.

In an example embodiment, in each case a position sensor is integrated into the first data processing device and into the second data processing device.

According to an example embodiment, the sensor unit(s) is/are designed for encrypting the surroundings sensor data, the particular communication interface of the sensor unit(s) being designed for wired transmission of the encrypted surroundings sensor data to the parking control unit. This yields in particular a technical advantage that the surroundings sensor data can be protected from unauthorized readout.

According to an example embodiment, the communication interface of the parking control unit is designed for outputting the data in encrypted form.

In an example embodiment, the communication module is designed for receiving the encrypted data.

According to an example embodiment, the first data processing device is designed for decrypting the encrypted data.

According to an example embodiment, the first data processing device is designed for encrypting unencrypted data and/or unencrypted surroundings data.

According to an example embodiment, the second data processing device is designed for decrypting the encrypted data and/or encrypted surroundings data.

According to an example embodiment, the second data processing device is designed for encrypting unencrypted data and/or unencrypted surroundings data.

According to an example embodiment, the parking control unit is designed for decrypting the encrypted surroundings sensor data.

According to an example embodiment, the parking control unit is designed for encrypting unencrypted data.

According to an example embodiment, the communication module is designed for transmitting the encrypted data and/or the encrypted surroundings data to the second data processing device via the wireless communications network.

According to an example embodiment, the second data processing device is designed for transmitting the encrypted data and/or the encrypted surroundings data to the cloud server via the further wireless communications network.

According to an example embodiment, the sensor units and/or the first data processing device and/or the second data processing device and/or the parking control unit each include(s) a processor that is designed for encrypting and/or decrypting the data and/or the surroundings data.

According to an example embodiment, the surroundings sensor data are raw surroundings sensor data or include raw surroundings sensor data.

Within the meaning of the description, a surroundings sensor is, for example, one of the following surroundings sensors: a radar sensor, a LIDAR sensor, an ultrasonic sensor, a magnetic sensor, a laser sensor, a video sensor, in particular a video sensor of a video camera, or an infrared sensor.

For multiple surroundings sensors, these have identical or different designs, for example.

The term “respective” encompasses in particular the term “and/or.”

In an example embodiment, the parking control unit is designed for at least semiautonomously, in particular fully autonomously, parking and/or unparking a motor vehicle. That the parking control unit is designed for at least semiautonomously, in particular fully autonomously, parking and/or unparking a motor vehicle means in particular that the parking control unit is designed for controlling transverse and/or longitudinal guiding of the motor vehicle.

In an example embodiment, the parking control unit is designed to ascertain, based on the surroundings sensor data, a distance of a motor vehicle from an object in the surroundings of the motor vehicle, for example during a parking and/or unparking operation of the motor vehicle. The parking control unit is preferably designed to output a warning based on the ascertained distance and/or to control a warning device to output a warning when the ascertained distance is less than or equal to a predefined threshold value. For example, the warning device includes an optical and/or haptic and/or acoustic signal generator. For example, the warning device includes a display device for displaying the warning.

As a result, this can yield, for example, a technical advantage that the driver of the motor vehicle can be efficiently warned so that a collision of the motor vehicle with the object can be avoided. The warning device is, for example, included by the device for detecting the surroundings or by the motor vehicle.

In an example embodiment, the parking control unit is designed to measure a vacant parking space, based on the surroundings sensor data, in response to a user command, in particular prior to a parking operation of the motor vehicle. The user command can come, for example, from the driver or another occupant of the motor vehicle. This means in particular that the parking control unit measures a vacant parking space upon request, based on the surroundings sensor data.

The parking control unit provides a result of this measurement, for example of a display device that displays the result. A result includes in particular the statement concerning whether or not the motor vehicle fits in the vacant parking space.

In an example embodiment, the first data processing device includes an electrical terminal for connecting an electrical line to allow the first data processing device to be supplied with electrical energy from a motor vehicle battery.

This yields, for example, a technical advantage that the first data processing device can be efficiently supplied with electrical energy.

In an example embodiment, the first data processing device is electroconductively connected to the motor vehicle battery using an electrical line that is connected to the electrical terminal.

According to an example embodiment, the method for detecting the surroundings of a motor vehicle is executed or carried out using the device for detecting the surroundings of a motor vehicle.

According to an example embodiment, the device for detecting the surroundings of a motor vehicle is designed or configured for executing or carrying out the method for detecting the surroundings of a motor vehicle.

Technical functionalities of the method for detecting the surroundings of a motor vehicle analogously result from corresponding technical functionalities of the device for detecting the surroundings of a motor vehicle, and vice versa.

According to an example embodiment, the first data processing device includes an electrical energy store for the internal electrical energy supply. This yields, for example, a technical advantage that the first data processing device can be operated autonomously. The electrical energy store includes, for example, one or more batteries and/or one or more accumulators.

According to an example embodiment, the motor vehicle is designed or configured for executing or carrying out the method for detecting the surroundings of a motor vehicle.

According to an example embodiment, the first data processing device according to the method for processing a motor vehicle is, for example, the first data processing device according to the device for detecting the surroundings of a motor vehicle.

Technical functionalities of the system for detecting the surroundings of a motor vehicle analogously result from corresponding technical functionalities of the method and/or the device for detecting the surroundings of a motor vehicle, and vice versa.

According to an example embodiment of the method for processing a motor vehicle, a second data processing device is installed in the motor vehicle. The second data processing device is, for example, a mobile terminal, in particular a mobile telephone, or a main control unit.

Technical functionalities of the method for processing a motor vehicle analogously result from corresponding technical functionalities of the device for detecting the surroundings of a motor vehicle, and vice versa.

According to an example embodiment of the present invention, a method for detecting the surroundings of a motor vehicle includes: wirelessly receiving the data and/or the surroundings data using the second data processing device; and transmitting the data and/or the surroundings data to the cloud server via the further wireless communications network using the second data processing device.

In an example embodiment, the motor vehicle includes a bus. The bus can be referred to, for example, as a motor vehicle bus and/or as a communication bus.

Surroundings sensor data refer to data that originate directly from the surroundings sensors and that can include raw surroundings sensor data, for example.

Surroundings data refer to data that have been computed or ascertained based on the surroundings sensor data. Surroundings data include, for example, dimensions of an occupied or unoccupied space and/or an occupancy state of a space.

The parking control unit and/or the first data processing device and/or the second data processing device can ascertain appropriate surroundings data, for example based on the surroundings sensor data (for the parking control unit, such surroundings data are referred to as data based on the surroundings sensor data). The first data processing device transmits the data in question to the second data processing device via the wireless communications network. The second data processing device transmits these received data, for example, directly to the cloud server and/or further processes these data itself and sends the further processed data to the cloud server. These further processed data can also be generally referred to as surroundings data, provided that they are based on the surroundings sensor data of the surroundings sensors. These further processed data can also be referred to below as further surroundings data.

In an example embodiment, the cloud server is designed to ascertain, based on the data and/or on the surroundings data, dimensions of a vacant space in the surroundings and/or dimensions of a space in the surroundings that is occupied by a motor vehicle, and to ascertain surroundings data corresponding to the ascertainment of the particular dimensions.

In an example embodiment, the first data processing device is designed for processing the data, for example surroundings sensor data, and transmitting the processed data, in particular the processed surroundings sensor data, to the second data processing device. Within the meaning of this description, the processed data constitute in particular surroundings data.

Processing includes, for example, compression and/or fusion of the data, in particular the surroundings sensor data.

For example, the first data processing device processes only the data, in particular the surroundings sensor data, i.e., does not compute dimensions of vacant and/or occupied parking spaces based on the surroundings sensor data, as described above. The second data processing device and/or the cloud server, for example, take(s) over this task.

In an example embodiment, the surroundings sensor data are received by wire using the communication interface of the parking control unit. The parking control unit uses these surroundings sensor data, for example as described above and/or explained below, to make computations, for example to ascertain dimensions of vacant parking spaces or parking areas.

The present invention is explained in greater detail below with reference to preferred exemplary embodiments.

### BRIEF DESCRIPTION OF THE DRAWINGS

FIG. 1 shows a device for detecting the surroundings of a motor vehicle according to an example embodiment of the present invention.

FIG. 2 is a flowchart that illustrates a method for detecting the surroundings of a motor vehicle according to an example embodiment of the present invention.

FIG. 3 is a flowchart of a method for perfecting a motor vehicle according to an example embodiment of the present invention.

FIG. 4 shows a motor vehicle according to an example embodiment of the present invention.

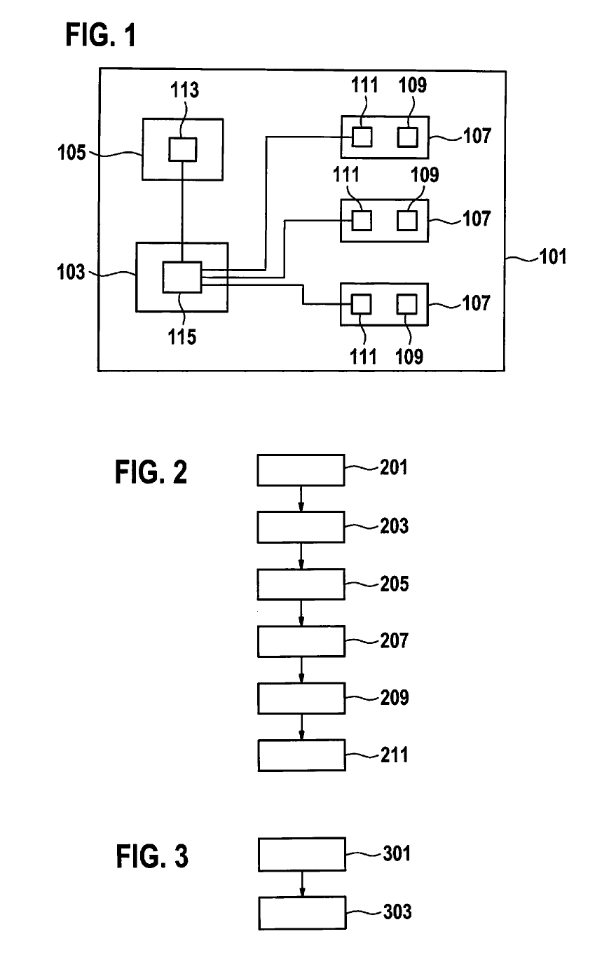

FIG. 1 shows a device 101 for detecting the surroundings of a motor vehicle according to an example embodiment of the present invention.

### DETAILED DESCRIPTION

Device 101 includes: a parking control unit 103, a first data processing device 105, and one or more sensor units 107 that each includes one or more surroundings sensors 109 for detecting the surroundings of a motor vehicle and a communication interface 111 for the wired transmission of surroundings sensor data corresponding to the particular detection, where the parking control unit 103 includes a communication interface 115 that is designed for receiving by wire the surroundings sensor data, the parking control unit 103 is connected between the particular communication interface 111 of the one or more sensor unit(s) 107 and first data processing device 105, the first data processing device 105 includes a communication module 113 that is designed for receiving by wire, using communication interface 115 of parking control unit 103, output data based on the surroundings sensor data, and the communication module 113 is designed for transmitting the data and/or surroundings data based on the data to a second data processing device via a wireless communications network, so that the second data processing device can transmit the data and/or the surroundings data to a cloud server via a further wireless communications network.

According to an example embodiment, device 101 includes the second data processing device, which is designed for transmitting the data and/or the surroundings data to the cloud server via the further wireless communications network.

According to an example embodiment, a motor vehicle is provided that includes device 101.

In an example embodiment, the first data processing device and/or the second data processing device include(s) a position sensor for detecting a position of the motor vehicle. The position sensor is a GPS sensor, for example.

Parking control unit 103 includes a control device, for example, that is designed for controlling transverse and/or longitudinal guiding of the motor vehicle.

FIG. 2 is a flowchart of a method for detecting the surroundings of a motor vehicle, using the device for detecting the surroundings of a motor vehicle, for example device 101 in FIG. 1. The method includes: detecting 201 the surroundings of a motor vehicle using the surroundings sensor(s); transmitting 203 by wire surroundings sensor data, corresponding to the detection, using the particular communication interface to the parking control unit; receiving 205 by wire the surroundings sensor data using the parking control unit; wired outputting 207 of data based on the surroundings sensor data using the communication interface of the parking control unit; wired reception 209 of the output data using the communication module of the first data processing device; and transmitting 211 the data and/or surroundings data based on the data to a second data processing device via a wireless communications network, using the first data processing device, so that the second data processing device can transmit the data and/or the surroundings data to a cloud server via a further wireless communications network.

According to an example embodiment, the second data processing device transmits the data and/or the surroundings data to the cloud server via the further wireless communications network.

FIG. 3 is a flowchart of a method for perfecting a motor vehicle, the motor vehicle including a parking control unit and one or more sensor units, each of which includes one or more surroundings sensors for detecting the surroundings of a motor vehicle and a communication interface for wired transmission of surroundings sensor data corresponding to the particular detection via a bus, in particular a CAN bus, of the motor vehicle, the parking control unit including a bus communication interface for wired reception of the surroundings sensor data via the bus, a first data processing device being installed 301 in the motor vehicle in such a way that the parking control unit is connected 303 between the particular communication interface of the one or more sensor unit(s) and the first data processing device, the first data processing device including a communication module that is designed for receiving, by wire, output data based on the surroundings sensor data using the communication interface of the parking control unit, the communication module being designed for transmitting the data and/or surroundings data based on the data to a second data processing device via a wireless communications network, so that the second data processing device can transmit the data and/or the surroundings data to a cloud server via a further wireless communications network.

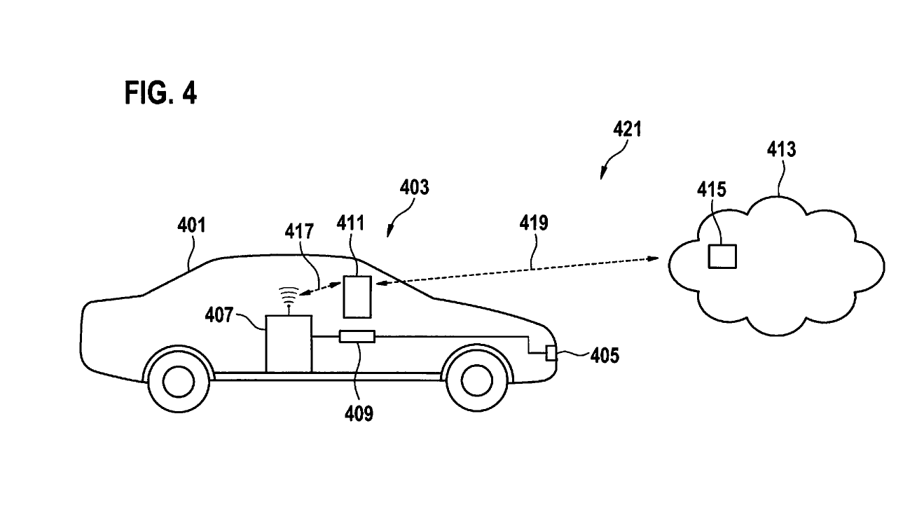

FIG. 4 shows a motor vehicle 401 that includes a device 403 for detecting the surroundings of a motor vehicle. Device 403 includes a sensor unit 405 that includes a surroundings sensor for detecting the surroundings of motor vehicle 401, and a communication interface for the wired transmission of surroundings sensor data corresponding to the particular detection to a parking control unit 409. For the sake of clarity, the communication interface and the surroundings sensor of sensor unit 405 are not shown.

Device 403 includes a first data processing device 407 and parking control unit 409, which is designed, for example, for at least semiautonomously, in particular fully autonomously, parking and/or unparking a motor vehicle, in the present case in particular motor vehicle 401. Parking control unit 409 includes a communication module (not shown) that is designed for the wired reception of the surroundings sensor data.

The communication interface of parking control unit 409 is designed for outputting data, based on the surroundings sensor data, for example to a bus of motor vehicle 401. Such data include, for example, the surroundings sensor data themselves and/or surroundings data.

First data processing device 407 includes a communication module (not shown). The communication module is designed for the wired reception of the output data of parking control unit 409. The communication module is also designed for transmitting the data and/or surroundings data based on the data to a second data processing device 411 via a wireless communications network, so that second data processing device 411 transmits and/or can transmit the data and/or the surroundings data and/or further surroundings data based on the data and/or based on the surroundings data to a cloud server 413 via a further wireless communications network.

The surroundings sensor of sensor unit 405 detects the surroundings of motor vehicle 401, and transmits surroundings sensor data corresponding to this detection to parking control unit 409 using the communication interface. This transmission is carried out by wire, for example via a bus of motor vehicle 401.

Parking control unit 409 ascertains, for example based on the surroundings sensor data, dimensions of a vacant space in the surroundings and/or dimensions of a space in the surroundings that is occupied by a motor vehicle, and ascertains surroundings data corresponding to the ascertainment of the particular dimensions.

Parking control unit 409 is connected between first data processing device 407 and sensor unit 405. The surroundings sensor data can thus reach first data processing device 407 only indirectly, i.e., via parking control unit 409.

First data processing device 407 ascertains, for example based on the data and/or the surroundings sensor data, dimensions of a vacant space in the surroundings and/or dimensions of a space in the surroundings that is occupied by a motor vehicle, and ascertains surroundings data corresponding to the ascertainment of the particular dimensions.

First data processing device 407 transmits these ascertained data to second data processing device 411 via a wireless communications network. Second data processing device 411 is encompassed by device 403, for example. Second data processing device 411 is encompassed by motor vehicle 401, for example. Second data processing device 411 is situated in particular within the motor vehicle.

Second data processing device 411 is, for example, a mobile terminal, such as a mobile telephone of a driver or an occupant of motor vehicle 401.

Second data processing device 411 is, for example, a main control unit of motor vehicle 401.

Second data processing device 411 includes, for example, a first communication interface, such as a WLAN or a Bluetooth communication interface, for receiving the data and/or the surroundings sensor data or the surroundings data from first data processing device 407 via the wireless communications network.

Second data processing device 411 encompasses, for example, a second communication interface, such as a mobile radio communication interface, for transmitting the data and/or the surroundings sensor data and/or the surroundings data and/or the further surroundings data to cloud server 413.

The communication module of first data processing device 407 includes, for example, a first communication interface, such as a bus communication interface, for the wired reception of the output data.

The communication module of first data processing device 407 includes, for example, a second communication interface, such as a WLAN communication interface or a Bluetooth communication interface, for wirelessly transmitting the data, for example the surroundings sensor data and/or the surroundings data, to second data processing device 411.

Cloud server 413 includes a communication interface 415 that is designed for receiving the surroundings sensor data and/or the surroundings data and/or the further surroundings data from second data processing device 411 via the further wireless communications network.

The communication between first data processing device 407 and second data processing device 409 is denoted by a double arrow having reference numeral 417.

The communication between second data processing device 411 and cloud server 413 is denoted by a double arrow having reference numeral 419.

Cloud server 413 is designed, for example, to ascertain, based on the received data, vacant and/or occupied parking spaces in the surroundings of motor vehicle 401 as well as their positions, for example their GPS positions.

These pieces of information, in particular the positions of the vacant or occupied parking areas or parking spaces, are transmitted, for example, to motor vehicle 401 via the further wireless communications network. These pieces of information are transmitted, for example, to other motor vehicles (not shown) via the further wireless communications network, so that they obtain information concerning where occupied and/or vacant, i.e., unoccupied, parking spaces or parking areas are situated.

Thus, FIG. 4 also shows a system 421 for detecting the surroundings of a motor vehicle.

System 421 includes device 403 and cloud server 413. Providing a cloud server 413 has a technical advantage in particular that the cloud server can carry out efficient computations. In particular, the cloud server 413 can efficiently receive a plurality of data and/or surroundings sensor data and/or surroundings data and/or further surroundings data from a plurality of motor vehicles, and correspondingly efficiently process same and transmit corresponding results of this processing and/or evaluation (the positions of the vacant and/or occupied parking spaces, for example) to the plurality of motor vehicles via the further wireless communications network.

According to an example embodiment, second data processing device 411 is designed for displaying the information of cloud server 413 that is transmitted via the further wireless communications network.

Second data processing device 411 includes, for example, a screen for displaying this information.

The present invention thus encompasses in particular the concept of installing an additional hardware component, the first data processing device, in a motor vehicle, which is connected downstream from the parking control unit in relation to the surroundings sensors, so that the surroundings sensor data of the surroundings sensors can reach the additional hardware component only indirectly via the parking control unit, the additional hardware component further processing the received data and wirelessly transmitting the further processed data, and/or the received data directly, to a second data processing device. This yields, for example, the technical advantage that, for example, no significant changes or modifications have to be made to a bus of a motor vehicle.

This means that the additional hardware component that is installed in the motor vehicle has two functionalities: cable-free or wireless communication in addition to wired communication. Within the meaning of the description, the terms “cable-free” and “wireless” can be used synonymously.

This means that the newly installed hardware component includes a communication module that is designed for communicating wirelessly via a wireless communications network, in particular for wirelessly transmitting the surroundings sensor data and/or the surroundings data to a second data processing device.

Thus, the surroundings sensor data, which can include raw surroundings sensor data, for example, and/or the surroundings data can be transmitted to the second data processing device, which is a mobile terminal, for example.

For example, the data are transmitted in encrypted form.

For example, a position sensor for detecting a position of the motor vehicle is provided, so that a position can be associated with the surroundings sensor data, and/or that a position can be associated with the surroundings data. This means that a position of the motor vehicle, i.e., appropriate position data, is/are linked to the surroundings data and/or the surroundings sensor data.

For example, the first data processing device and/or the second data processing device include(s) a position sensor, so that the data processing device and/or the further data processing device can detect or determine a position of the motor vehicle at the point in time that the surroundings of the motor vehicle are detected.

According to an example embodiment, the first data processing device and/or the second data processing device and/or the parking control unit are/is designed to ascertain, based on the surroundings sensor data and/or based on the surroundings data, dimensions of a vacant space in the surroundings and/or dimensions of a space in the surroundings that is occupied by a motor vehicle, and to ascertain surroundings data, in the present case the further surroundings data, corresponding to the ascertainment of the particular dimensions. The dimensions together with the corresponding positions of the vacant spaces and/or the occupied spaces are then transmitted to the cloud server via the further wireless communications network, for example using the second data processing device.

According to an example embodiment, in addition to or instead of the above-described ascertainment of the dimensions of the vacant spaces and/or the occupied spaces using the first data processing device and/or using the parking control unit and/or using the second data processing device, the computations in question are carried out using the cloud server.

According to an example embodiment, the cloud server is designed for computing further data, based on the received data (surroundings sensor data, surroundings data, or further surroundings data, for example), for example whether a vacant space is an entry point. For example, the cloud server ascertains whether a parking facility is completely full or whether there are still vacant parking spaces within a parking facility.

The data ascertained or computed by the cloud server are preferably transmitted to the second data processing device and/or to other motor vehicles via the further wireless communications network, so that the second data processing device, and/or the data processing devices of the other motor vehicles, can display these pieces of information.

According to an example embodiment, the second data processing device is a “head unit,” i.e., a main control unit. According to this example embodiment, the main control unit includes a cable-free communication interface. This means that the cable-free communication interface can communicate wirelessly. For example, the communication interface of the main control unit can communicate wirelessly via Bluetooth and/or WLAN.

This means that according to this example embodiment, the data are transmitted wirelessly from the additional hardware component to the main control unit, and from the main control unit are then transmitted wirelessly to the cloud server via the further wireless communications network.

It is usual for a motor vehicle to already have a main control unit that includes an infotainment system, for example. A main control unit that is already present in the motor vehicle generally already includes a communication module for wireless communication. In currently known motor vehicles, it is provided via such a communication module that the main control unit communicates with a mobile telephone of a vehicle occupant, for example to play music, stored on the mobile telephone, using the infotainment system.

Thus, it is no longer necessary to make modifications to the main control unit with regard to hardware. Rather, it is sufficient for such a main control unit to obtain a software update. This is generally done with little effort, and in addition there are no extra hardware costs,

Thus, the present invention provides an advantage in particular that existing motor vehicles, i.e., motor vehicles that are already manufactured, can become part of a system for also subsequently ascertaining vacant or occupiable parking spaces on a roadside. This is achieved according to the present invention using the device or by installing an additional hardware component, in particular in addition to the parking control unit.

In particular, it is not necessary to make significant changes on or in the bus of the motor vehicle.

In particular, it is not necessary to install additional position detection components in the motor vehicle, provided that the first data processing device already includes a position sensor.

In particular, it is not necessary to make changes to the main control unit except for the software update, provided that the communication with the cloud server is not to be carried out, for example, via a mobile telephone, but instead via the main control unit.

In particular, it is not necessary to make changes to the parking control unit.

In particular, it is not necessary to make changes to the sensor units.

1-19. (canceled)

20. A device comprising:
a first data processor;
one or more sensor units that each includes:
one or more surroundings sensors for detecting surroundings of a motor vehicle; and
a communication interface for wired transmission of surroundings sensor data of the one or more surroundings sensors; and
a parking controller that is connected between the first data processor and the one or more communication interfaces of the one or more sensor units and that includes a communication interface for receiving the surroundings sensor data by wire;
wherein:
the first data processor includes a communication module for receiving, by wire and via the communication interface of the parking controller, output data based on the surroundings sensor data; and
the communication module is configured to transmit at least one of the output data and the surroundings sensor data to a second data processor via a wireless communications network, so that the second data processor is able to transmit the at least one of the output data and the surroundings sensor data to a cloud server via a further wireless communications network.

21. The device of claim 20, further comprising the second data processor, wherein the second data processor is configured for transmitting the at least one of the output data and the surroundings sensor data to the cloud server via the further wireless communications network.

22. The device of claim 20, wherein the second data processor is a mobile terminal.

23. The device of claim 20, wherein the second data processor is a mobile telephone.

24. The device of claim 20, wherein the second data processor is a main control unit for a motor vehicle.

25. The device of claim 20, wherein the communication module of the first data processor is directly connected to an output side of the communication interface of the parking controller.

26. The device of claim 20, wherein the communication module of the first data processor is connected to the communication interface of the parking controller via a bus line.

27. The device of claim 20, wherein the communication module of the first data processor is connected to the communication interface of the parking controller via a CAN bus line.

28. The device of claim 20, wherein the communication module includes a first communication interface for wired data reception and a second communication interface data transmission to the second data processor.

29. The device of claim 28, wherein the first communication interface is a bus communication interface and the second communication interface is WLAN or Bluetooth communication interface.

30. The device of claim 20, wherein at least one of the parking controller, the first data processor, and the second data processor is configured to: (a) ascertain, based on the surroundings sensor data, dimensions of at least one of a vacant space in the surroundings and a space in the surroundings that is occupied by a motor vehicle; and (b) ascertain surroundings data corresponding to the ascertainment of the dimensions.

31. The device of claim 20, further comprising a position sensor, wherein the first data processor is configured to transmit position data, corresponding to a detection by the position sensor of a position of the vehicle, to the second data processor, for transmission by the second data processor of the position data to the cloud server via a further wireless communications network.

32. The device of claim 31, wherein the position sensor is integrated with the first data processor or with the second data processor.

33. The device of claim 20, wherein the one or more sensor units is configured for encrypting the surroundings sensor data, and the respective communication interface of the respective sensor unit is configured for wired transmission of the encrypted surroundings sensor data to the parking controller.

34. The device of claim 20, wherein the first data processor includes an electrical terminal for connecting an electrical line to allow the first data processor to be supplied with electrical energy from a motor vehicle battery.

35. The device of claim 20, wherein the first data processor includes an electrical energy store for the internal electrical energy supply.

36. A vehicle comprising a device that includes:
a first data processor;
one or more sensor units that each includes:
one or more surroundings sensors for detecting surroundings of a motor vehicle; and
a communication interface for wired transmission of surroundings sensor data of the one or more surroundings sensors; and
a parking controller that is connected between the first data processor and the one or more communication interfaces of the one or more sensor units and that includes a communication interface for receiving the surroundings sensor data by wire;
wherein:
the first data processor includes a communication module for receiving, by wire and via the communication interface of the parking controller, output data based on the surroundings sensor data; and
the communication module is configured to transmit at least one of the output data and the surroundings sensor data to a second data processor via a wireless communications network, so that the second data processor is able to transmit the at least one of the output data and the surroundings sensor data to a cloud server via a further wireless communications network.

37. A method performed using a device that includes (a) a first data processor, (b) one or more sensor units that each includes one or more surroundings sensors for detecting surroundings of a motor vehicle and a communication interface for wired transmission of surroundings sensor data of the one or more surroundings sensors, and (c) a parking controller that is connected between the first data processor and the one or more communication interfaces of the one or more sensor units and that includes a communication interface for receiving the surroundings sensor data by wire, the method comprising:
the one or more surroundings sensors performing the detecting of the surroundings of the motor vehicle;
transmitting by wire the surroundings sensor data corresponding to the detection using the respective communication interface of the respective one or more sensor units;
the parking controller receiving by wire the surroundings sensor data;
wired outputting of output data that is based on the surroundings sensor data via the communication interface of the parking controller;
the first data processor receiving the output data by wired reception via a communication module of the first data processor and via the communication interface of the parking controller; and
the first data processor transmitting, via the communication module, the at least one of the output data and the surroundings sensor data to the second data processor via a wireless communications network so that the second data processor is able to transmit the at least one of the output data and the surroundings sensor data to a cloud server via a further wireless communications network.

38. A method for perfecting a motor vehicle, wherein the motor vehicle includes one or more sensor units that each includes one or more surroundings sensors for detecting surroundings of a motor vehicle and a communication interface for wired transmission of surroundings sensor data of the one or more surroundings sensors over a bus of the motor vehicle, the method comprising:
providing in the motor vehicle a parking controller that includes a communication module that is configured for wired reception of the surroundings sensor data via the bus and for transmitting at least one of the surroundings sensor data and output data that is based on the surroundings sensor data; and
installing a second data processor in the motor vehicle such that the parking controller is connected between the second data processor and the one or more communication interfaces of the one or more sensor units, wherein the second data processor includes a communication module for:
receiving, by wire, the output data that is based on the surroundings sensor data via the communication interface of the parking controller; and
transmitting the at least one of the surroundings sensor data and the output data to the first data processor via a wireless communications network, so that the first data processor is able to transmit the at least one of the surroundings sensor data and the output data to a cloud server via a further wireless communications network.

39. A system comprising:
a cloud server that includes a communication interface; and
a device that includes:
a first data processor;
one or more sensor units that each includes:
one or more surroundings sensors for detecting surroundings of a motor vehicle; and
a communication interface for wired transmission of surroundings sensor data of the one or more surroundings sensors; and
a parking controller that is connected between the first data processor and the one or more communication interfaces of the one or more sensor units and that includes a communication interface for receiving the surroundings sensor data by wire;
wherein:
the first data processor includes a communication module for receiving, by wire and via the communication interface of the parking controller, output data based on the surroundings sensor data; and
the communication module is configured to transmit at least one of the output data and the surroundings sensor data to a second data processor via a wireless communications network, so that the second data processor is able to transmit the at least one of the output data and the surroundings sensor data to the cloud server via a further wireless communications network and the communication interface of the cloud server.

40. The system of claim 39, wherein the cloud server is configured to ascertain, based on the at least one of the output data and the surroundings sensor data, dimensions of at least one of a vacant space in the surroundings and a space in the surroundings that is occupied by a motor vehicle, and is configured to ascertain surroundings data corresponding to the ascertained dimensions.

41. A non-transitory computer-readable medium on which are stored instructions that are executable by a device that includes (a) a first data processor, (b) one or more sensor units that each includes one or more surroundings sensors for detecting surroundings of a motor vehicle and a communication interface for wired transmission of surroundings sensor data of the one or more surroundings sensors, and (c) a parking controller that is connected between the first data processor and the one or more communication interfaces of the one or more sensor units and that includes a communication interface for receiving the surroundings sensor data by wire, wherein the instructions, when executed by the device, cause the device to perform a method, the method comprising:
transmitting by wire the surroundings sensor data corresponding to the detection using the respective communication interface of the respective one or more sensor units;
the parking controller receiving by wire the surroundings sensor data;
wired outputting of output data that is based on the surroundings sensor data via the communication interface of the parking controller;
the first data processor receiving the output data by wired reception via a communication module of the first data processor and via the communication interface of the parking controller; and
the first data processor transmitting, via the communication module, the at least one of the output data and the surroundings sensor data to the second data processor via a wireless communications network so that the second data processor is able to transmit the at least one of the output data and the surroundings sensor data to a cloud server via a further wireless communications network.
